(19) United States
(12) Patent Application Publication
(10) Pub. No.: US 2016/0070901 A1
(43) Pub. Date: Mar. 10, 2016

(54) DEVICE AND METHOD FOR AUTHENTICATING ON BASIS OF POSITION VALUE

(71) Applicant: MOBI SOLUTION CO., LTD, Seoul (KR)

(72) Inventor: Changjoon KIM, Gunpo-si (KR)

(21) Appl. No.: 14/888,284

(22) PCT Filed: Jan. 20, 2014
(86) PCT No.: PCT/KR2014/000541

§ 371 Date: Oct. 30, 2015

(30) Foreign Application Priority Data
May 6, 2013 (KR) 10-2013-0050709

(51) Int. Cl. G06F 21/34

(52) U.S. Cl. CPC G06F 21/34

(57) ABSTRACT

The present invention relates to a device and a method for authenticating on the basis of position value, and comprises the steps of: registering, by the authentication device, position value information for authentication; outputting a symbol string including symbols corresponding to position values; selecting a symbol included in the outputted symbol string; and comparing the selected symbol with a symbol corresponding to a registered position value in the symbol string to determine whether the symbols match each other, and security is remarkably improved therethrough.

### TECHNICAL FIELD

The present invention relates to an authentication technique, and more specifically, to a device and method for authenticating based on a position value capable of improving security, when performing authentication on a terminal, a door lock, a web site, various types of user accounts, and the like, by allowing a user to input of specific information.

### BACKGROUND ART

Terminals, such as a computer, a smart phone, and the like, that are commonly used in office or home have an authentication technique through input of a password to prevent from being used by an unauthorized user. Also, a door of a building has a locking device, called as a door lock, and controls access to the door lock by allowing a visitor to input a password into the corresponding door lock.

However, the method of authenticating based on a password has a problem of loss of security when the corresponding password is exposed, and particularly, has a limit in which someone peeps a motion of pressing the password or someone easily figures out the password by following handprints that appear on a touchscreen, etc.

To secure the vulnerability of security using the password, although a one time password (OTP)-type security method has been proposed, this also has a problem of becoming vulnerable to the security when algorism for generating OTP is spilled.

### DISCLOSURE

### Technical Problem

The present invention is directed to providing a device and method for authenticating based on a position value capable of improving security reliability, when a user is authenticated, by performing authentication using a position value showing which symbol is in a symbol string in which a plurality of symbols are arranged.

### Technical Solution

One aspect of the present invention provides a method of authenticating based on a position value, the method including a registering step of registering, by an authentication device, information on a position value for authentication; an outputting step of outputting, by the authentication device, a symbol string including a symbol corresponding to the position value; a selecting step of selecting, by the authentication device, a symbol included in the output symbol string; and a determining step of comparing, by the authentication device, the selected symbol with the symbol corresponding to the position value in the symbol string to determine whether the symbols match each other.

In the method of authenticating based on a position value of the present invention, the registering step may include selecting the number of the position values for authentication and registering the information on the selected number of position values.

In the method of authenticating based on a position value of the present invention, the method may further include a step of unlocking when confirmed that the symbols match each other as a result of the determination in the determining step.

In the method of authenticating based on a position value of the present invention, as a result of the determining step, when the symbols do not match each other, a mismatch message or alarm sound may be output, or an attempt at unlocking may be notified.

In the method of authenticating based on a position value of the present invention, the registering step may include registering information on a plurality of position values including specific position values and other position values, and the determining step may include determining whether the symbols selected by the authentication device match symbols corresponding to the specific position values of the symbol string or symbols corresponding to the other position values.

In the method of authenticating based on a position value of the present invention, the other position values may be determined with a part of the specific position values, position values including a part of the specific position values, or position values including the entire specific position values, or may be determined separately from the specific position values.

In the method of authenticating based on a position value of the present invention, as a result of the determination in the determining step, an authority according to the authentication may be discriminatorily given depending on whether the symbols selected by the authentication device are the symbols corresponding to the specific position values or the symbols corresponding to the other position values.

In the method of authenticating based on a position value of the present invention, as a result of the determination in the determining step, an owner, a manager, a security or a police may be informed when the symbols selected by the authentication device are the symbols corresponding to the other position values.

In the method of authenticating based on a position value of the present invention, the symbol string may be a string of symbols selected from general characters, special characters, and numbers.

Another aspect of the present invention provides a computer-readable recording medium recording a program causing a computer to execute the method.

Still another aspect of the present invention provides a device for authenticating based on a position value, the device including an input unit configured to input information, an output unit configured to display the information, a storing unit configured to store the information; and a control unit configured to register position value information for authentication through the input unit to store the position value information in the storing unit, output a symbol string including a symbol corresponding to the position value to the output unit, and compare, when a symbol included in the output symbol string is selected through the input unit, the selected symbol with a symbol corresponding to the position value in the symbol string to determine whether the symbols match each other.

In the device for authenticating based on a position value of the present invention, the control unit may select the number of the position values for authentication through the input unit, and may register the information on the selected number of the position values.

In the device for authenticating based on a position value of the present invention, the control unit may perform unlocking when confirmed that the symbols match each other as a result of the determination in the determination step.

In the device for authenticating based on a position value of the present invention, when the symbols do not match each other as a result of the determination of the control unit, the control unit may output a mismatch message or alarm sound through the output unit or may notify an attempt at unlocking.

In the device for authenticating based on a position value of the present invention, the control unit may register information on a plurality of position values including specific position values and other position values, and may determine whether the selected symbols are symbols corresponding to the specific position values in the symbol string or to symbols corresponding to the other position values.

In the device for authenticating based on a position value of the present invention, the other position values may be determined with a part of the specific position values, position values including a part of the specific position values, or position values including the entire specific position values, or determined separately from the specific position values.

In the device for authenticating based on a position value of the present invention, as a result of the determination of the control unit, the control unit may discriminatorily give an authority according to the authentication depending on whether the symbols selected by the authentication device are the symbols corresponding to the specific position values or the symbols corresponding to the other position values.

In the device for authenticating based on a position value of the present invention, the device may further include a communication unit configured to transmit and receive the information, and the control unit, when the selected symbols are the symbols corresponding to the other position values, wherein the control unit may inform an owner, a manager, a security, or a police through the communication unit.

In the device for authenticating based on a position value of the present invention, the symbol string may be a string of symbols selected from general characters, special characters, and numbers.

### Advantageous Effects

According to an authentication device and method based on a position value according to the present invention, a specific symbol of a random symbol string is selected and input using a position value memorized in a user's brain, which means that the final security key is a user him/herself rather than static information, such as a password. Therefore, there is no risk in security key theft and security is remarkably improved.

Also, the conventional password method or the method using one time password (OTP) may be stolen and used by someone else, so it is impossible to completely secure security; however, in the present invention, an appropriate authorized person, a user him/herself, should be involved in a process of selecting the specific symbols of the random symbol string to authenticate the user him/herself, thereby strengthening the security.

### DESCRIPTION OF DRAWINGS

FIG. 1 is a block diagram illustrating a configuration of an authentication device according to an embodiment of the present invention;

FIG. 2 is an exemplary diagram illustrating a symbol corresponding to a symbol string and a position value according to the embodiment of the present invention;

FIG. 3 is a flowchart illustrating an authentication process according to the embodiment of the present invention; and

FIG. 4 is a flowchart illustrating an authentication process according to another embodiment of the present invention.

### MODES OF THE INVENTION

In describing the present invention, it is noted that only the portion of description required to understand the embodiment of the present invention will be described and the other description will be omitted so as not to obscure the gist of the present invention.

The terms and words used in the present specification and claims to be described below should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Therefore, the configurations described in the embodiments and drawings of the present invention are merely the most preferable embodiments but do not represent all of the technical spirits of the present invention. Thus, the present invention should be construed as including all the changes, equivalents, and substitutions included in the spirit and scope of the present invention at the time of filing this application.

The present invention relates to a technique for authenticating a proper authorized user. Hereafter, the embodiment of the present invention will be described in more detail with reference to the attached drawings.

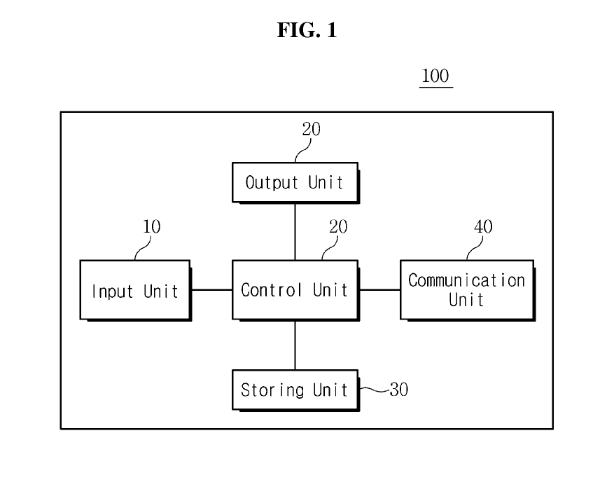

FIG. 1 is a block diagram illustrating a configuration of an authentication device 100 according to an embodiment of the present invention. The authentication device 100 in the embodiment may be various types of terminal devices, such as a computer, a laptop, an appliance, a smart phone, a mobile phone, a personal digital assistant (PDA), and an MP3 player, and the like, that require authentication for its use or require to input authentication information to a specific website, etc. by using the authentication. Also, the authentication device 100 may be a device installed to control access of unauthorized person, such as a door lock installed in a door, and further, may be one of various devices performing user authentication.

Referring to FIG. 1, the authentication device 100 of the embodiment is configured to include an input unit 10, an output unit 20, a storing unit 30, a communication unit 40, and a control unit 50.

The input unit 10, used to input information to the authentication device 100, may be any device generating an input signal according to the input of a user, such as a keypad, a number pad, a touch pad, a touch screen, a button, a keyboard, a mouse, and the like. The user may input general characters, special characters, numbers, and the like, through the input unit 10, and the input information is transmitted to the control unit 50.

The output unit 20, used to display information of the authentication device 100 according to control of the control unit 50, includes a screen, such as an LCD etc., a touch screen, and a speaker, and the like, that visually and acoustically show various information. If the output unit 20 includes the touch screen, the output unit 20 functions as both the input unit 10 and the output unit 20.

The storing unit 30 configured to store information includes at least one volatile or nonvolatile memory element, and stores various application programs for operating the authentication device 100 and various information according to control of the control unit 50.

The communication unit 40 for transmitting and receiving information through a communication network includes a communication interface for transmitting and receiving information. Here, the communication unit 40 may transmit information in a wired or wireless manner.

The control unit 50 controls a general operation of the authentication device including the input unit 10, the output unit 20, the storing unit 30, and the communication unit 40, and may include a calculation unit for the control.

In the embodiment, the control unit 50 includes the storing unit 30 for registering position value information for authentication through the input unit 10 and storing the registered position value information in the storing unit 30. In this case, the number of the position values for the authentication may be a predetermined value, and may be a value selected by the user that the control unit 50 receives at the time of setting for authentication. When the control unit 50 receives the number of position values for authentication selected by the user, the control unit 50 registers position value information as much as the number of the position values selected through the input unit 10. For example, when the control unit 50 receives two selected position values for the authentication to be used, the control unit 50 may register the position values 2 and 4 through the input unit 10. In this case, second and fourth symbols included in the symbol string are used for the authentication.

After that, when the user attempts authentication, the control unit 50 generates a symbol string including random symbols by using the position value information stored in the storing unit 30 and outputs the symbol string to the output unit 20.

The position value in the present invention is the information on which symbol is to be input in the symbol string in which a plurality of symbols are arranged. Here, the symbol string may be a string of symbols selected from general characters, special characters, and numbers, and the number, and the arrangement of the symbols included in the symbol string may be determined at random.

For example, assume that position values 2 and 4 are registered in the control unit 50 as position value information used for authentication. When the user attempts authentication, the control unit 50 generates a random character string including at least four symbols including the symbols corresponding to the position values 2 and 4. If the control unit 50 generates br1z0he96w of the symbol string, the symbols corresponding to the position values 2 and 4 refer to a symbol ‘r’ in the second position and a symbol ‘z’ in the fourth position of the corresponding symbol string.

The control unit 50 outputs the generated symbol string to the output unit 20. The user confirms the symbols, corresponding to the pre-registered position values, in the symbols included in the output symbol string, and selects and inputs the symbols using the input unit 10.

For example, when the symbols output to the output unit 20 are br1z0he96w as described above and the pre-registered position values are the position values 2 and 4, the user confirms the symbol ‘r’ in the second position and the symbol ‘z’ in the fourth position of the corresponding symbol string, and selects and inputs the symbols using the input unit 10.

After that, the control unit 50 compares the symbols selected and input through the input unit 10 with the symbols, corresponding to the registered position values, of the symbol string output in the output unit 20, and determines whether the symbols match each other.

For example, when the symbols selected and input through the input unit 10 as described above are ‘r’ and ‘z’, the control unit 50 confirms that the position values 2 and 4 pre-registered in the symbol string ‘br1z0he96w ’ as described above are the symbols ‘r’ and ‘z’ and confirms that the symbols match each other.

As a result of the determination of the control unit 50, when it is confirmed that the symbols selected through the input unit and the symbols corresponding to the position values of the symbol string match each other, after confirming the successful user authentication, the control unit 50 unlocks the terminal to be used by the user, or unlocks the door to allow the user to access.

As a result of the determination of the control unit 50, when it is confirmed that the symbols selected through the input unit and the symbols corresponding to the position value of the symbol string do not match, the control unit 50 outputs a message indicating the mismatch between both of the symbols, and outputs alarm sound according to the mismatch or indicates an attempt at unlocking. In this case, the control unit 50 may indicate the attempt at unlocking to an owner of a remote place, a manager, a security, a police, or the like through the communication unit 40, and the alarm operation may be performed when authentication attempts more than a certain number of times or the continuous mismatches of the symbols are confirmed.

In an embodiment of the present invention, the control unit 50 may resister information on a plurality of position values used for authentication through the input unit 10, wherein the information on the plurality of position values includes specific position values and other position values.

Here, the other position values may be determined with a part of the specific position values, position values including a part of the specific position values, or position values including the entire specific position values, or determined separately from the specific position values. For example, when the specific position values are position values 2 and 4, the other position values may be the position value 2 which is a part of specific position values, position values 2 and 5 including a part of the specific position values, position values 2, 4, and 5 including the entire specific position values, or position values 3 and 5 completely unrelated with the specific position values.

After that, the control unit 50 outputs the symbol string, including the symbols corresponding to the specific position values and the other position values, to the output unit 20, and the symbols, included in the symbol string, are selected through the input unit 10 and are input into the control unit 50.

The control unit 50 determines whether the symbols, selected through the input unit 10, match the symbols, corresponding to the specific position values of the symbol string output in the output unit 20, or the symbols corresponding to the other position values.

Here, the control unit 50 may discriminately give an authority according to the authentication depending on whether the symbols selected through the input unit 10 are the symbols corresponding to the specific position values or the symbols corresponding to the other position values. For example, when the symbols selected through the input unit 10 are the symbols corresponding to the specific position values, the control unit 50 may allow the entire function of the terminal, etc. to be used. On the other hand, when the symbols selected through the input unit 10 are the symbols corresponding to the other position values, the control unit 50 may allow only a partial function of the terminal, etc. to be restrictively used. Therefore, the control unit 50 may discriminately give a plurality of users the authority according to the authentication.

Also, the control unit 50 unlocks the terminal, the door, or the like when the selected symbols are the symbols corresponding to the specific position values, and may inform an owner, a manager, a security or a police through the communication unit 40 when the corresponding selected symbols are the symbols corresponding to the other position values. Therefore, when the symbols according to the other position values other than the typical specific position values are input, the management authority may immediately confirm a security situation, and may deal with the authentication attempt through input of random symbols.

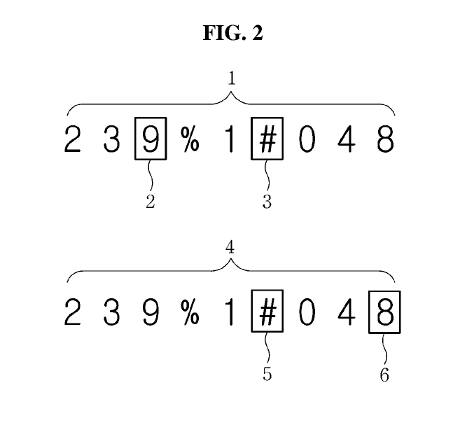

The method in which the authentication device 100 according to the present invention outputs the symbol string and performs authentication by selecting the symbols corresponding to the position values will be described in detail with reference to FIG. 2.

FIG. 2 is an exemplary diagram illustrating a symbol corresponding to a symbol string and a position value according to the embodiment of the present invention.

Referring to FIG. 2, the plurality of symbol strings 1 and 4 are shown, the corresponding symbol strings 1 and 4 are formed of sequential symbols “239% 1#048”, respectively. In the embodiment, the user registers a plurality of position values in the authentication device, and when the symbol strings 1 and 4 are output in the authentication device, selects the symbol corresponding to any one position value of the corresponding position values to perform an authentication process.

In the embodiment, the authentication device received the specific position values formed of position values 3 and 6 and the other position values formed of position values 6 and 8 as a plurality of position values for authentication. In this case, the position values 3 and 6 refer to the third and sixth symbols of the symbol string to be used for authentication, and the position values 6 and 8 refer to the sixth and eighth symbols to be used for authentication. At this time, the authentication device is set that the specific position value and other position value include the position value 6 in common.

When the symbol string 1 is output to a screen of the authentication device, the user confirms that the symbol 2 corresponding to the position value 3 in the sequential symbols “239% 1#048” included in the symbol string 1 is “9” and the symbol 3 corresponding to the position value 6 is “#”. The user inputs the corresponding symbols “9” and “#” using a keypad, etc. of the authentication device, and the authentication device performs an authentication process by confirming that the symbols “9” and “#”, corresponding to the pre-registered position values 3 and 6 of the symbol string, are the input symbols “9” and “#”.

Likewise, when the symbol string 4 is output to a screen of the authentication device, the user confirms that the symbol 5 corresponding to the sixth position value in sequential symbols “239%1#048” included in the symbol string 4 is “#” and the symbol 6 corresponding to the position value 8 is “4”. The user inputs the corresponding symbols “#” and “4” using the keypad of the authentication, and the authentication device performs an authentication process by confirming that the symbols “#” and “4” corresponding to the pre-registered position values 6 and 8 of the symbol string are the input symbols “#” and “4”.

Here, the authentication result may be changed depending on whether the symbols, selected by the user to perform authentication, in the symbol string output by the authentication device are the symbols “9” and “#” corresponding to the specific position values (position values 3 and 6) or the symbols “#” and “4” corresponding to the other position values (position values 6 and 8).

For example, when the user selects and inputs the symbols “9” and “#” corresponding to the specific position values (position values 3 and 6), an authentication given according to the authentication may be discriminated from an authentication given when the symbols “#” and “4” corresponding to other position value (position values 6 and 8) are selected and input. A function used in the terminal or information accessed by the user may be discriminatorily determined

Also, when the user selects and inputs the symbols “9” and “#” corresponding to the specific position values (position values 3 and 6), it is considered as an appropriate authentication, so the terminal or door is unlocked, or account log-in for a website is performed. On the other hand, when the symbols “#” and “4” corresponding to the other position values (position values 6 and 8) are selected and input, it is concerned as an inappropriate authentication attempt or an emergency situation, so the authentication device may be set to inform an owner, a manager, a security, or a police. Here, when the symbols “#” and “4” corresponding to the other position values (position values 6 and 8) are selected and input, the authentication device may perform an operation of unlocking or log-in and an operation of informing other person or the remote place at the same time. Therefore, the user may inform other person or the remote place of an authentication attempt by an unauthorized person, and when the unauthorized person attempts a random authentication, may detect and notify the random authentication attempt by the unauthorized person.

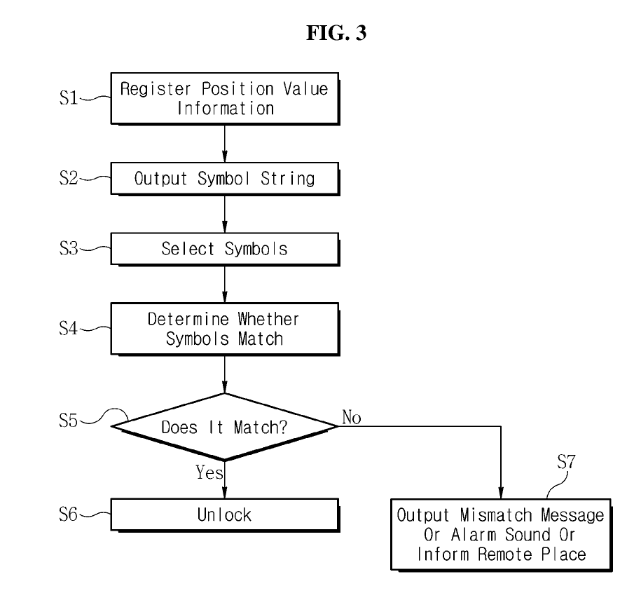

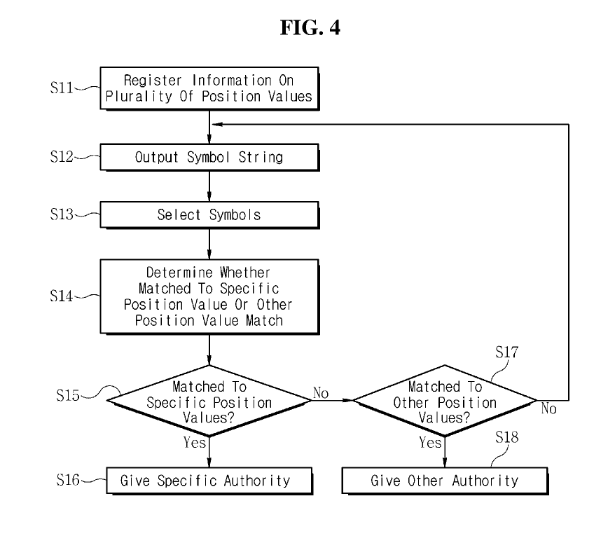

In the present invention, a process for performing authentication using the position values will be described in detail with reference to FIGS. 3 and 4.

FIG. 3 is a flowchart illustrating an authentication process according to the embodiment of the present invention.

Referring to FIG. 3, the authentication device registers the position value information for authentication (S1).

The authentication device in the step S1 selects the number of position values for authentication, and may register the information on the selected number of position values. For example, when the authentication device selects three position values for authentication to be used, position values 3, 6, and 8 may be registered as the corresponding three position values. In this case, the symbol in the third position, the symbol in the sixth position, and the symbol in the eight position of the symbol string are used for authentication.

After that, as the user attempts the authentication, the authentication device generates the symbol string in which the random symbols are arranged using the position value information registered in the step S1 and visually outputs the symbol string (S2).

The symbol string generated in the step S2 may be a string of the symbols selected from the general characters, special characters, and numbers, and the number or arrangement of the symbols included in the symbol string may be randomly determined.

For example, when the position values 3, 6, and 8 are registered in the step S1, the authentication device in the step S2 generates the symbol string including eight or more symbols by including the symbol corresponding to the largest position value 8. Here, it is preferable that the symbols corresponding to the position values 3, 6, and 8 are not overlapped with other symbols in the symbol string.

The authentication device receives the symbols, according to a selection of a user, of the symbol string output in the step S2 (S3), and determines whether the symbols corresponding to the position values registered in the step S1 and the symbols according to the selection of the user match each other by comparing the symbols (S4).

That is, the user in the step S3 may select and input the symbols, corresponding to the registered position values that the user remembers, in the symbol string output in the step S2. The authentication device in the step S4 may perform an authentication process by comparing whether the symbols of the position values that the user remembers and the symbols of the position values pre-registered in the step S1 match each other.

As a result of the determination in the step S4, when the both symbols match each other (S5), the authentication device unlocks a terminal or a door to be used by the user (S6).

Also, as the result of the determination in the step S4, when the both symbols do not match each other (S5), the authentication device takes an appropriate measure by outputting a discordance message or alarm sound or informing a remote place of the authentication attempt (S7).

According to the embodiment, the authentication device in the step S6 may perform various operations, such as user account log-in, and the authentication device in the step S7 may not allow authentication or may perform various operations, such as taking other additional measure.

FIG. 4 is a flowchart illustrating an authentication process according to another embodiment of the present invention.

Referring to FIG. 4, the authentication device registers information on a plurality of position values for authentication (S11).

That is, the authentication device in the step S11 may register a plurality of position values including specific position values having a specific authentication purpose, and the other position values having other authentication purpose.

Here, the authentication device in the step S11 selects the number of the position values for the authentication for each specific position value and other position value and registers information on the selected number of position values.

After that, as the user attempts the authentication, the authentication device generates the symbol string in which the symbols are arranged in consecutive order using the position value information registered in the step S11, and visually outputs the symbol string (S12).

The symbol string generated in the step S12 may be a string of the symbols selected from the general character, the special character, and the number, and the number or arrangement of the symbols included in the symbol string may be randomly determined Here, it is preferable that the authentication device generates the symbol string including the symbols, corresponding to the largest position value, with reference to the information on the plurality of position values.

The authentication device receives the symbols, selected by the user, of the symbol string output in the step S12 (S13), and determines whether the symbols, selected by the user, match the symbols corresponding to the specific position values registered in the step S11 or to the symbols corresponding to the other position values by comparing the symbols (S14).

That is, the user in the step S13 may select and input the symbols, corresponding to the registered position values that the user remembers, in the symbol string output in the step S12. The authentication device in the step S14 may perform an authentication process by comparing whether the symbols of the position values memorized by the user match the symbols of the position values pre-registered in the step S11.

As a result of the determination in the step S14, when the symbols selected and input by the user match the symbols corresponding to the specific position values (S15), the authentication device may give a corresponding specific authority (S16).

Also, as the result of the determination in the step S14, when the symbols selected and input by the user match the symbols corresponding to the other position values (S17), the authentication device may give other corresponding authority (S18).

As the result of the determination of the step S14, if the symbols selected and input by the user do not match any one among the symbols corresponding to the specific position values or the other position values, the authentication device may not perform any operation. If the mismatched symbols are repeatedly input more than predetermined numbers, the authentication device may output a message of mismatch or alarm sound, or perform informing

When the authentication device in the step S15 according to an embodiment confirms that the symbols selected and input by the user are the symbols corresponding to the specific position values, it is considered as normal authentication, so the authentication device of the step S16 may unlock the terminal, the door, or the like or may perform the website account log-in. Also, when the authentication device in the step S17 confirms that the symbols selected and input by the user match the symbols corresponding to the other position values, it is considered as an abnormal authentication attempt or an emergency situation, so the authentication device in the step S18 may inform an owner, a manager, a security, or a police.

Meanwhile, the authentication method according to the embodiment of the present is performed in a program form readable through various types of computer means, and may be recorded in a recording medium readable by a computer.

The embodiments disclosed in the specification and the drawings are described with reference to specific examples to help an understanding, but are not limited to the range of the present invention. It will be apparent to those skilled in the art that various modifications and alterations based on the technical spirit of the present invention other than the embodiments disclosed herein might be made. Also, specific terms used in the specification and the drawings are used as a general meaning to easily describe a technique and understand the present invention only, but are not intended to be limiting of the range of the present invention.

1. A method of authenticating based on a position value, the method comprising:
a registering step of registering, by an authentication device, information on a position value for authentication;
an outputting step of outputting, by the authentication device, a symbol string including a symbol corresponding to the position value;
a selecting step of selecting, by the authentication device, a symbol included in the output symbol string; and
a determining step of comparing, by the authentication device, the selected symbol with the symbol corresponding to the position value in the symbol string to determine whether the symbols match each other.

2. The method of claim 1, wherein the registering step includes selecting the number of the position values for authentication and registering the information on the selected number of position values.

3. The method of claim 1, further comprising a step of unlocking when confirmed that the symbols match each other as a result of the determination in the determining step.

4. The method of claim 1, wherein, as a result of the determination in the determining step, when the symbols do not match each other, a mismatch message or alarm sound is output, or an attempt at unlocking is notified.

5. The method of claim 1, wherein the registering step includes registering information on a plurality of position values including specific position values and other position values, and the determining step includes determining whether the symbols selected by the authentication device match symbols corresponding to the specific position values of the symbol string or symbols corresponding to the other position values.

6. The method of claim 5, wherein the other position values are determined with a part of the specific position values, position values including a part of the specific position values, or position values including the entire specific position values, or determined separately from the specific position values.

7. The method of claim 5, wherein, as a result of the determination in the determining step, an authority according to the authentication is discriminatorily given depending on whether the symbols selected by the authentication device are the symbols corresponding to the specific position values or the symbols corresponding to the other position values.

8. The method of claim 5, wherein, as a result of the determination in the determining step, an owner, a manager, a security or a police is informed when the symbols selected by the authentication device are the symbols corresponding to the other position values.

9. The method of claim 1, wherein the symbol string is a string of symbols selected from general characters, special characters, and numbers.

10. A computer-readable recording medium recording a program causing a computer to execute the method according to claim 1.

11. A device for authenticating based on a position value, comprising:
an input unit configured to input information;
an output unit configured to display the information;
a storing unit configured to store the information; and
a control unit configured to register position value information for authentication through the input unit to store the position value information in the storing unit, output a symbol string including a symbol corresponding to the position value to the output unit, and compare, when a symbol included in the output symbol string is selected through the input unit, the selected symbol with a symbol corresponding to the position value in the symbol string to determine whether the symbols match each other.

12. The device of claim 11, wherein the control unit selects the number of the position values for authentication through the input unit, and registers the information on the selected number of the position values.

13. The device of claim 11, wherein the control unit performs unlocking when confirmed that the symbols match each other as a result of the determination in the determination step.

14. The device of claim 11, wherein when the symbols do not match each other as a result of the determination of the control unit, the control unit outputs a mismatch message or alarm sound through the output unit or notifies an attempt at unlocking.

15. The device of claim 11, wherein the control unit registers information on a plurality of position values including specific position values and other position values, and determines whether the selected symbols are symbols corresponding to the specific position values in the symbol string or to symbols corresponding to the other position values.

16. The device of claim 15, wherein the other position values are determined with a part of the specific position values, position values including a part of the specific position values, position values including the entire specific position values, or determined separately from the specific position values.

17. The device of claim 15, wherein, as a result of the determination of the control unit, the control unit discriminatorily gives an authority according to the authentication depending on whether the symbols selected by the authentication device are the symbols corresponding to the specific position values or the symbols corresponding to the other position values.

18. The device of claim 15, further comprising a communication unit configured to transmit and receive the information,
wherein the control unit, when the selected symbols are the symbols corresponding to the other position values, informs an owner, a manager, a security, or a police through the communication unit.

19. The device of claim 11, wherein the symbol string is a string of symbols selected from general characters, special characters, and numbers.
